(19) United States
(12) Patent Application Publication
(10) Pub. No.: US 2026/0235497 A1
(43) Pub. Date: Aug. 13, 2026

(54) INFORMATION PROCESSING APPARATUS, INFORMATION PROCESSING METHOD, PROGRAM, IMAGE PROCESSING DEVICE, AND IMAGE PROCESSING METHOD

(71) Applicant: Sony Semiconductor Solutions Corporation, Kanagawa (JP)

(72) Inventor: Seichi OTSUKI, Kanagawa (JP)

(73) Assignee: Sony Semiconductor Solutions Corporation, Kanagawa (JP)

(21) Appl. No.: 19/469,409

(22) PCT Filed: Apr. 18, 2024
(86) PCT No.: PCT/JP2024/015479

§ 371 Date: Sep. 26, 2025

Related U.S. Application Data
(60) Provisional application No. 63/462,005, filed on Apr. 26, 2023.

(51) Int. Cl. G01N 21/25

(52) U.S. Cl. CPC G01N 21/251; G01N 21/255; G01N 2201/127

(57) ABSTRACT

A time required for deriving a spectral sensitivity correction coefficient of a spectral sensor is reduced, and a processing load is reduced. An information processing apparatus according to the present technology includes a coefficient deriving unit that derives a spectral sensitivity correction coefficient of a spectral sensor on the basis of calibration subject spectral characteristic information that is spectral characteristic information obtained on the basis of a sensing result of the spectral sensor for a calibration subject having a known spectral characteristic and spectral characteristic information of a target subject that is a subject different from the calibration subject and has a known spectral characteristic.

### CROSS REFERENCE TO RELATED APPLICATIONS

This application claims priority to, and the benefit of, U.S. provisional patent application Ser. No. 63/462,005 filed on Apr. 26, 2023, incorporated herein by reference in its entirety.

### TECHNICAL FIELD

The present technology relates to an information processing apparatus, an information processing method, a program, an image processing device, and an image processing method, and particularly relates to a technical field related to spectral sensitivity correction of a spectral sensor.

### BACKGROUND ART

A spectral sensor (multi spectrum sensor) for obtaining a plurality of narrow-band images to be a wavelength characteristic analysis image for light from a subject, in other words, an analysis image of a spectral characteristic of the subject is known, and furthermore, an application for performing various analyses of the subject on the basis of spectral information obtained by the spectral sensor, for example, estimating a vegetative state of a plant or estimating a human skin state on the basis of the plurality of narrow-band images has been developed.

In the spectral sensor, it is considerably difficult to design an optical filter for separately receiving light of a plurality of wavelengths, and there is a variation in sensitivity for each wavelength, and it is desired to correct the variation. This variation in sensitivity occurs between individual spectral sensors, and it is desirable to perform sensitivity correction for each spectral sensor.

In related art, derivation of a spectral sensitivity correction coefficient used for spectral sensitivity correction is performed by using spectral information obtained by sensing a calibration subject having a known spectral characteristic with a spectral sensor. Specifically, the spectral sensitivity characteristic of the spectral sensor is estimated on the basis of a plurality of pieces of spectral information obtained by sensing a plurality of calibration subjects with the spectral sensor and information (that is, correct answer information) on the spectral characteristics of the calibration subjects, and an inverse function (pseudo inverse matrix) thereof is obtained as the spectral sensitivity correction coefficient.

Note that PTLs 1 and 2 below can be cited as a related past technology. PTL 1 below discloses a technology in which in a soil analysis method for irradiating soil with light and analyzing the characteristic of the soil from a soil spectrum obtained from reflected light reflected by the soil, a plurality of waveform groups approximating the waveform is generated from a set of waveforms of a soil spectrum obtained from a plurality of soils, a feature spectrum in each of the waveform groups is obtained, and the characteristic of the soil is analyzed by comparing the feature spectrum with a soil spectrum obtained from a soil having a new characteristic.

Furthermore, PTL 2 below discloses a technology in which in a method for spectroscopic measurement adapted to receive light and then measure a spectrum representing intensity of the light at a first number of predetermined wavelengths, the method includes: dispersing the light received into lights with measurement wavelengths, which are a second number of predetermined wavelengths; generating a measured spectrum having the second number of light intensity values by detecting the light intensity at the second number of measurement wavelengths; determining a transformation matrix adapted to convert the measured spectrum into the spectrum; and converting the measured spectrum into the spectrum by making the transformation matrix act on the measured spectrum, and the determining of a transformation matrix includes: performing principal component analysis on the measured spectrum obtained from predetermined reference measurement equipment to previously select a third number of principal component vectors, the third number being smaller than the second number; obtaining a known light measured spectrum, which is the measured spectrum of known light as light having a known spectrum; converting the known light measured spectrum into a reference known light measured spectrum by linearly projecting the known light measured spectrum to a linear space constituted by the third number of principal component vectors; and determining the transformation matrix based on a condition in which an evaluation function, which is defined by a linear combination of a difference between an estimated spectrum as the spectrum obtained by making the transformation matrix act on the reference known light measured spectrum and a known light spectrum, and dispersions of respective components constituting the transformation matrix, takes an extreme value.

### CITATION LIST

### Patent Literature

PTL 1: JP 2006-038511A
PTL 2: JP 2014-038042A

### SUMMARY

### Technical Problem

Here, in order to enhance the accuracy of the spectral sensitivity correction, it is effective to increase the number of types of calibration subjects used for deriving the spectral sensitivity correction coefficient. However, increasing the number of types of calibration subjects means increasing the number of samples used for deriving the spectral sensitivity correction coefficient, which leads to an increase in the amount of processing required for the derivation and leads to an increase in time and processing load required for the derivation.

The present technology has been made in view of the above-described problems, and it is desirable to reduce the time required for deriving the spectral sensitivity correction coefficient of the spectral sensor and reduce the processing load.

### Solution to Problem

An information processing apparatus according to the present technology includes a coefficient deriving unit that derives a spectral sensitivity correction coefficient of a spectral sensor on the basis of calibration subject spectral characteristic information that is spectral characteristic information obtained on the basis of a sensing result of the spectral sensor for a calibration subject having a known spectral characteristic and spectral characteristic information of a target subject that is a subject different from the calibration subject and has a known spectral characteristic.

When the spectral characteristic information of the target subject is used to derive the spectral sensitivity correction coefficient, it is possible to derive the spectral sensitivity correction coefficient corresponding to a case where the subject to be sensed by the spectral sensor is narrowed down to the target subject, instead of deriving the spectral sensitivity correction coefficient corresponding to any subject, which enables reduction in the number of samples required for deriving the spectral sensitivity correction coefficient and reduction in the processing amount required for deriving the spectral sensitivity correction coefficient.

Furthermore, an image processing device according to the present technology includes a spectral sensitivity correction unit that performs spectral sensitivity correction processing on a spectral image obtained on the basis of an output of a spectral sensor by using a spectral sensitivity correction coefficient derived by an information processing apparatus including a coefficient deriving unit that derives the spectral sensitivity correction coefficient of the spectral sensor on the basis of calibration subject spectral characteristic information that is spectral characteristic information obtained on the basis of a sensing result of the spectral sensor for a calibration subject having a known spectral characteristic and spectral characteristic information of a target subject that is a subject different from the calibration subject and has a known spectral characteristic.

The spectral sensitivity correction coefficient derived by the information processing apparatus as described above is derived such that the processing amount required for deriving the spectral sensitivity correction coefficient can be reduced.

### BRIEF DESCRIPTION OF DRAWINGS

FIG. 1 is a block diagram illustrating a schematic configuration example of a spectral camera as a target in an embodiment.

FIG. 2 is a diagram schematically illustrating a configuration example of a pixel array unit included in a spectral sensor.

FIG. 3 is an explanatory diagram of band-narrowing processing according to the embodiment.

FIG. 4 is a diagram illustrating a configuration example of a coefficient derivation system including an information processing apparatus as the embodiment.

FIG. 5 is a diagram illustrating an example of spectral reflectance information of a calibration subject.

FIG. 6 is a diagram illustrating an example of spectral reflectance information of a target subject.

FIG. 7 is a block diagram illustrating a schematic configuration example of the information processing apparatus as the embodiment.

FIG. 8 is a functional block diagram illustrating each function for coefficient derivation included in the information processing apparatus as the embodiment.

FIG. 9 is a diagram for explaining a function of a coefficient deriving unit according to the embodiment.

FIG. 10 is a flowchart of convolution processing according to the embodiment.

FIG. 11 is a flowchart of error calculation processing according to the embodiment.

FIG. 12 is a block diagram illustrating a schematic configuration example of the Image processing device as the embodiment.

FIG. 13 is a diagram for explaining a function of a coefficient deriving unit in another example of the embodiment.

FIG. 14 is a block diagram illustrating a schematic configuration example of an image processing device as another example of the embodiment.

FIG. 15 is a block diagram of a computer-based system on which embodiments of the present system may be implemented.

### DESCRIPTION OF EMBODIMENTS

Hereinafter, embodiments according to the present technology will be described in the following order with reference to the accompanying drawings.

<1. Spectral camera>
<2. Derivation of coefficient as embodiment>
(2-1. System configuration)
(2-2. Configuration of information processing apparatus)
(2-3. Specific example of coefficient derivation method)
(2-4. image processing device as embodiment)
(2-5. Another example of embodiment)

### <3. Modifications>

### <4. Program>

### <5. Notes>

<6. Summary of embodiment>
<7. Present technology>

### 1. Spectral Camera

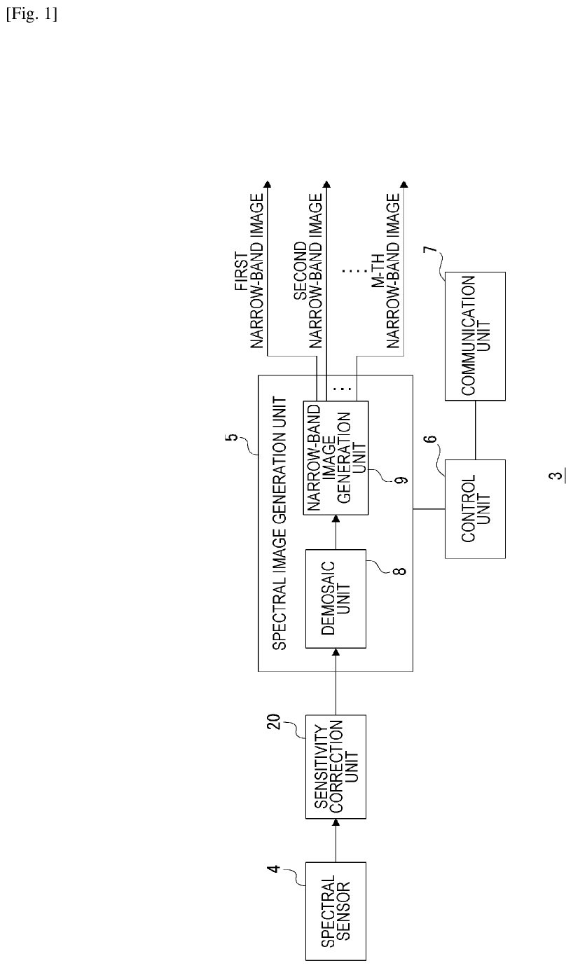

First, an example of a spectral camera targeted by the present technology will be described with reference to FIGS. 1 to 3.

FIG. 1 is a block diagram illustrating a schematic configuration example of a spectral camera 3 as a target in an embodiment.

Here, the “spectral camera” means a camera including a spectral sensor as a light receiving sensor. The “spectral sensor” is a light receiving sensor for obtaining a plurality of narrow-band images to be a wavelength characteristic analysis image for light from a subject.

As illustrated, the spectral camera 3 includes a spectral sensor 4, a spectral image generation unit 5, a control unit 6, a communication unit 7, and a sensitivity correction unit 20.

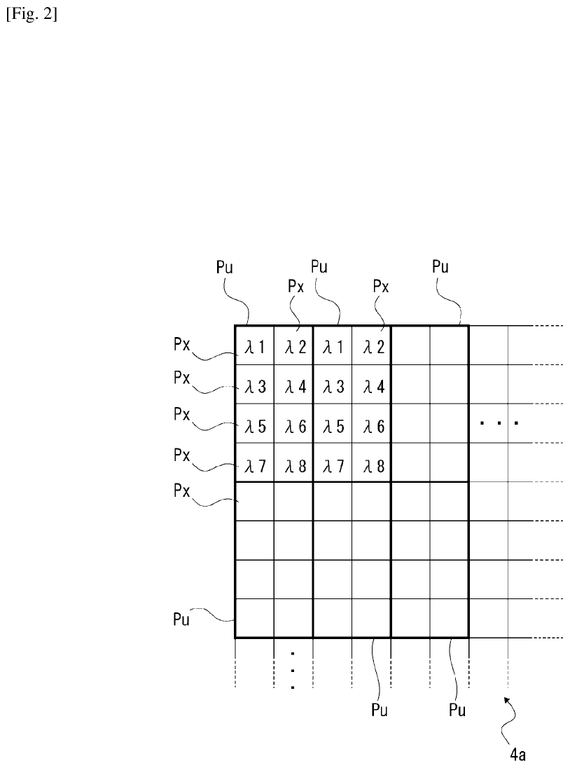

FIG. 2 is a diagram schematically illustrating a configuration example of a pixel array unit 4a included in the spectral sensor 4.

As illustrated, in the pixel array unit 4a, a spectral pixel unit Pu is formed in which a plurality of pixels Px each receiving light of different wavelength bands is two-dimensionally arranged in a predetermined pattern. The pixel array unit 4a has a plurality of spectral pixel units Pu arranged two-dimensionally.

In the example of the drawing, an example in which each of the spectral pixel units Pu individually receives light of a total of eight wavelength bands of A1 to 28 in each of the pixels Px, in other words, an example in which the number of wavelength bands divided to be received in each of the spectral pixel units Pu (hereinafter referred to as “the number of light receiving wavelength channels”) is “8” is illustrated, but this is merely an example for description, and it is sufficient if the number of light receiving wavelength channels in the spectral pixel unit Pu is at least a plurality, and the number can be arbitrarily set.

Hereinafter, the number of light receiving wavelength channels in the spectral pixel unit Pu is referred to as “N”.

In FIG. 1, the sensitivity correction unit 20 performs spectral sensitivity correction processing on a spectral image obtained on the basis of the output of the spectral sensor 4. The spectral sensitivity correction is correction of spectral sensitivity variation of the spectral sensor 4.

Specifically, the sensitivity correction unit 20 of the present example performs the spectral sensitivity correction processing on a RAW image as the image output from the spectral sensor 4.

Note that it is sufficient if the spectral sensitivity correction processing here is performed at least at a preceding stage of band-narrowing processing to be described later, and for example, it is also conceivable to perform the spectral sensitivity correction processing on the spectral image after demosaic processing by a demosaic unit 8 to be described later.

The spectral image generation unit 5 generates M narrow-band images on the basis of the RAW image (in the present example, the RAW image after the spectral sensitivity correction processing) output from the spectral sensor 4. Here, it is assumed that “M>N”, and for example, M=41 with respect to N=8.

The spectral image generation unit 5 includes the demosaic unit 8 and a narrow-band image generation unit 9. The demosaic unit 8 performs the demosaic processing on the RAW image from the spectral sensor 4, and the narrow-band image generation unit 9 performs band-narrowing processing (linear matrix processing) based on each of wavelength band images for N channels obtained by the demosaic processing, thereby generating M narrow-band images from the N wavelength band images.

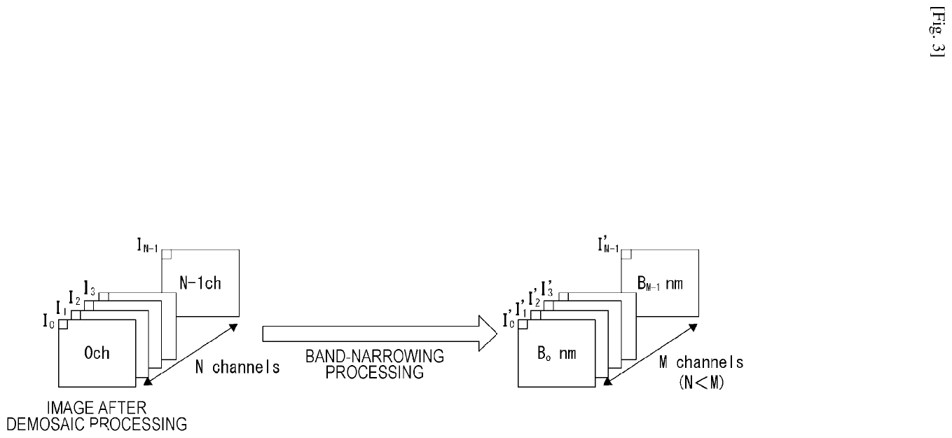

FIG. 3 is an explanatory diagram of the band-narrowing processing for obtaining M narrow-band images.

On the basis of the wavelength band images for N channels obtained by the demosaic processing by the demosaic unit 8, a predetermined matrix calculation is performed for each pixel position to obtain narrow-band images for M channels. In order to convert the wavelength band images for N channels into narrow-band images for M channels in this manner, processing of obtaining pixel values (in the drawing, I′0 to I′M−1) for M channels by the matrix calculation using the pixel values (in the drawing, I0 to IN−1) for N channels for each pixel position is the band-narrowing processing.

Here, when a pixel value after the demosaic processing is R, an input wavelength channel is n (0 to N−1), a band-narrowing coefficient is C, an output pixel value by the band-narrowing processing is B, and an output wavelength channel is m (0 to M−1), a calculation equation of the band-narrowing processing can be expressed by the following [Equation 1].

$$\begin{matrix}[ Math . l ] & \\ B m = {\sum }_{n = 0}^{N - 1} ( R [ n ] * C m [ n ] ) & [ Equation l ]\end{matrix}$$

That is, a pixel value B0 of the output wavelength channel of m=0th=R[0]×C0[0]+R[1]×C0[1]+R[2]×C0[2]+, . . . +R[N−1]×C0[N−1], and furthermore, a pixel value B1 of the output wavelength channel of m=1st=R[0]×C1[0]+R[1]×C1[1]+R[2]×C1[2]+, . . . +R[N−1]×C1[N−1].

Thereafter, similarly, the pixel value BM−1 of the last m=M−1 output wavelength channel=R[0]×CM−1[0]+R[1]×CM−1[1]+R[2]×CM−1[2]+, . . . +R[N−1]×CM−1[N−1].

At this time, as the band-narrowing coefficient C, a total N×M of C0[0] to C0[N−1] for obtaining the pixel value B, C1[0] to C1[N−1] for obtaining the pixel value B1, . . . , and CM−1[0] to CM−1[N−1] for obtaining the pixel value BM-1 is used.

In FIG. 1, the control unit 6 includes a microcomputer including, for example, a central processing unit (CPU), a read only memory (ROM), a random access memory (RAM), and the like, and performs overall control of the spectral camera 3 by causing the CPU to execute processing based on, for example, a program stored in the ROM or a program loaded in the RAM.

The communication unit 7 performs wired or wireless data communication with an external device. For example, the communication unit 7 is conceivable to have a configuration which performs wired data communication with an external device according to a predetermined wired communication standard such as a universal serial bus (USB) communication standard, wireless data communication with an external device according to a predetermined wireless communication standard such as a Bluetooth (registered trademark) communication standard, or wireless or wired data communication with an external device via a predetermined network such as the Internet.

The control unit 6 can transmit and receive data to and from an external device via the communication unit 7.

### 2. Derivation of Coefficient as Embodiment

### (2-1. System Configuration)

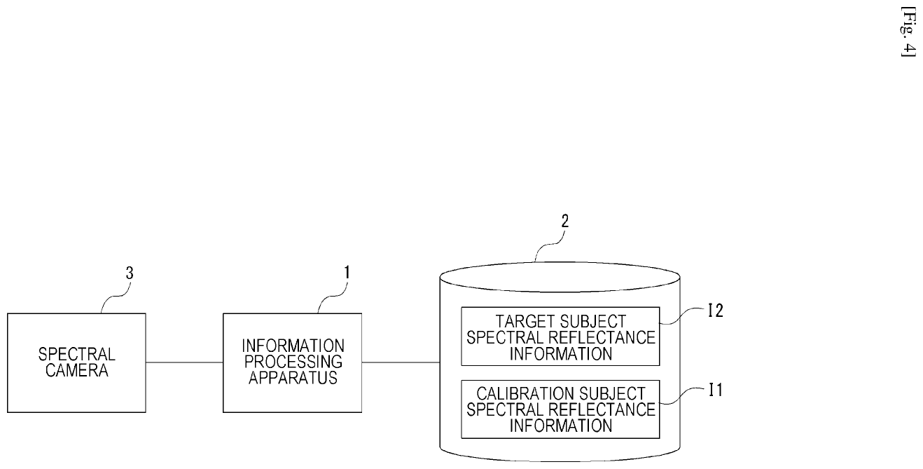

FIG. 4 is a diagram illustrating a configuration example of an algorithm derivation system including an information processing apparatus 1 as an embodiment of the information processing apparatus according to the present technology.

As illustrated, the algorithm derivation system as the embodiment includes the information processing apparatus 1, a database 2, and a spectral camera 3.

The information processing apparatus 1 is configured as a computer device, and performs processing of deriving a spectral sensitivity correction coefficient for correcting a spectral sensitivity variation in the spectral camera 3 as described later. The information processing apparatus 1 in the present example derives the spectral sensitivity correction coefficient on the basis of calibration subject spectral reflectance information I1 and target subject spectral reflectance information I2 stored in a storage device as the database 2.

Here, the “calibration subject” is a subject having a known spectral characteristic selected as a subject used for deriving the spectral sensitivity correction coefficient. As the calibration subject, for example, an artificially created image such as an image showing a test chart created for deriving the spectral sensitivity correction coefficient is used.

Furthermore, the “target subject” means a subject assumed as a sensing target at the time of actual use of the spectral camera and having a known spectral characteristic. As understood from the above description, examples of the application of the spectral camera include an application to plants (for example, an agricultural application), an application to human skin, and the like. For example, in the agricultural application, the target subject is narrowed down to vegetables such as tomato, cucumber, and corn, fruits such as apple, orange, and strawberry, and the like. Furthermore, in the case of an application to human skin, the target subject is narrowed down to only human skin. At this time, regarding the human skin, for example, it is conceivable to assume a plurality of target subjects such as skin of white race, skin of black race, and skin of yellow race.

Here, the terms in the present specification will be organized.

In the present specification, the term “spectral information” means information indicating light intensity for each wavelength.

Furthermore, the “spectral reflectance information” means information indicating the light reflectance for each wavelength.

The “spectral characteristic information” is a concept including both “spectral information” and “spectral reflectance information”, and means information indicating a characteristic of light for each wavelength.

In the present example, in deriving the spectral sensitivity correction coefficient, the spectral reflectance information of a plurality of calibration subjects is used as the spectral reflectance information of the calibration subject.

Furthermore, in the present example, it is assumed that a plurality of target subjects is selected, and the spectral reflectance information of the plurality of target subjects is used in deriving the spectral sensitivity correction coefficient.

Hereinafter, the number of calibration subjects used in deriving the spectral sensitivity correction coefficient is denoted as “S”. Furthermore, the number of target subjects used in deriving the spectral sensitivity correction coefficient is denoted as “T”.

As an example, it is conceivable to set S=31, T=10, and the like, but these numerical values are merely examples, and S and T can be set to arbitrary numbers.

In the database 2 illustrated in FIG. 4, the spectral reflectance information of each of the S calibration subjects is stored in the calibration subject spectral reflectance information I1.

Similarly, the spectral reflectance information of each of the T target subjects is stored in the target subject spectral reflectance information I2.

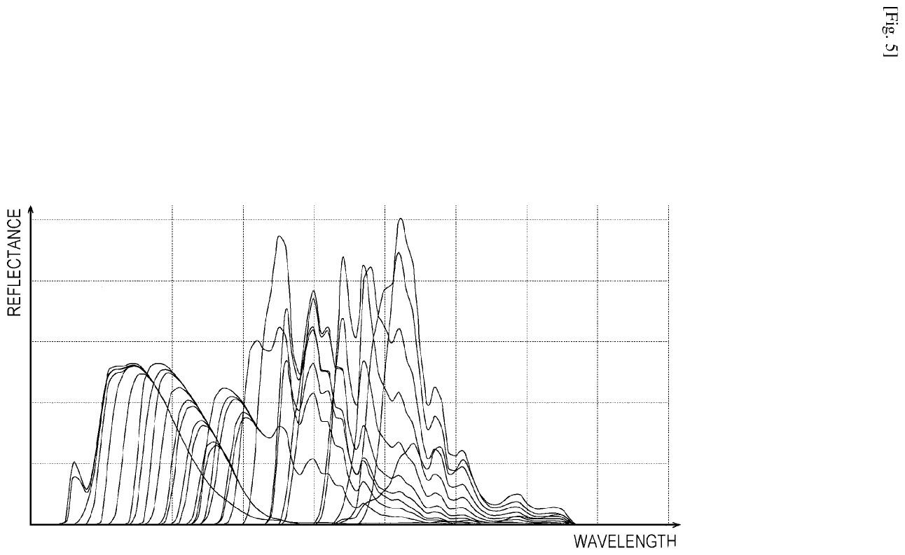

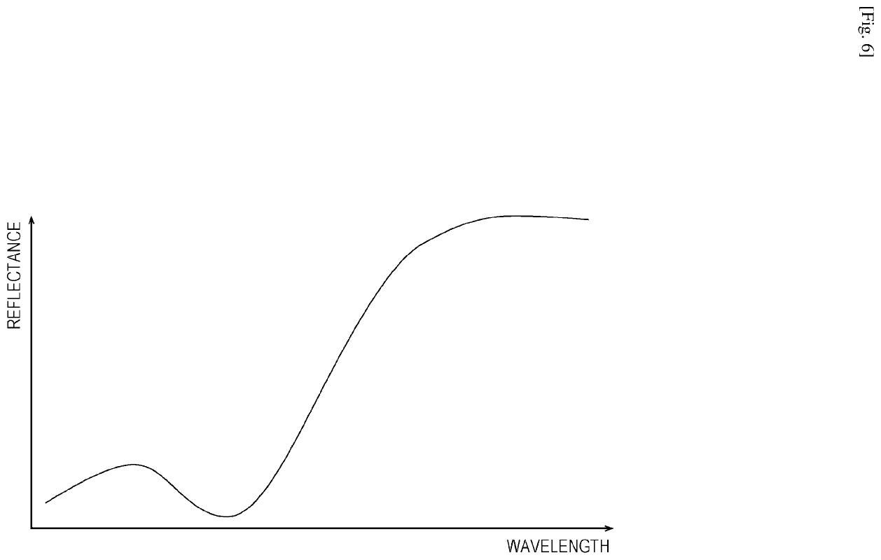

FIGS. 5 and 6 illustrate examples of the spectral reflectance information of the calibration subject and the spectral reflectance information of the subject, respectively.

Note that, in FIG. 5, the spectral reflectance information of the S (31 in this example) calibration subjects is illustrated in an overlapping manner.

In FIG. 4, the information processing apparatus 1 in the present example also performs processing for setting the spectral sensitivity correction coefficient to the spectral camera 3. Specifically, when deriving the spectral sensitivity correction coefficient, the information processing apparatus 1 in the present example performs processing of appropriately setting the spectral sensitivity correction coefficient as a candidate in the spectral camera 3 (sensitivity correction unit 20). Furthermore, the information processing apparatus 1 also performs processing of setting a spectral sensitivity correction coefficient derived by a derivation method to be described later in the spectral camera 3 (sensitivity correction unit 20).

Note that it is not essential for the information processing apparatus 1 itself to transmit the spectral sensitivity correction coefficient derived by the information processing apparatus 1 to the spectral camera 3. For example, it is conceivable that the spectral sensitivity correction coefficient derived by the information processing apparatus 1 is stored on a cloud, and the spectral camera 3 acquires the spectral sensitivity correction coefficient from the cloud.

### (2-2. Configuration of Information Processing Apparatus)

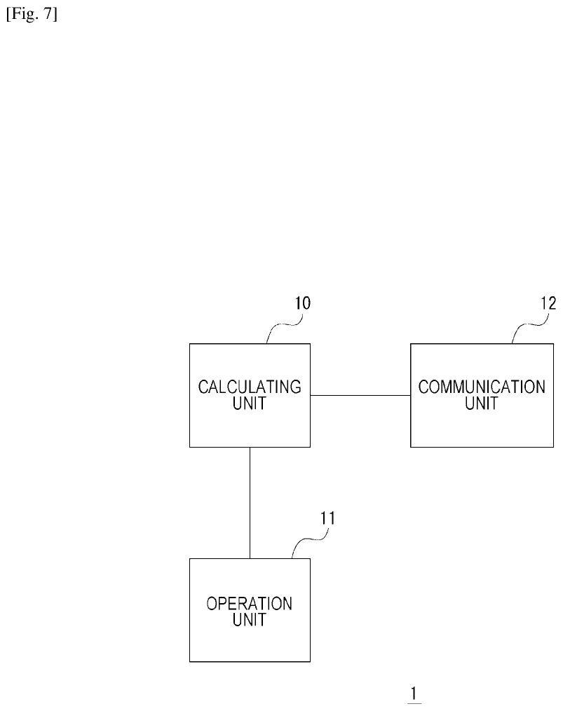

FIG. 7 is a block diagram illustrating a schematic configuration example of the information processing apparatus 1.

As illustrated, the information processing apparatus 1 includes a calculating unit 10, an operation unit 11, and a communication unit 12.

The calculating unit 10 includes, for example, a microcomputer including a CPU, a ROM, a RAM, and the like, and performs predetermined calculation and overall control of the information processing apparatus 1 by causing the CPU to execute processing based on a program stored in the ROM or a program loaded in the RAM.

The operation unit 11 includes various operators such as a keyboard, a mouse, a key, a dial, a touch panel, and a touch pad for a user to perform an operation input to the information processing apparatus 1, and outputs an operation signal corresponding to an operation on the operators to the calculating unit 10.

The calculating unit 10 executes processing according to the operation signal. Therefore, the processing of the information processing apparatus 1 according to the user operation is realized.

The communication unit 12 performs wired or wireless data communication with an external device (particularly, the database 2 or the spectral camera 3 illustrated in FIG. 4 in the present example). Similarly to the communication unit 7 described above, the communication unit 12 is conceivable to have a configuration which performs wired data communication with an external device according to a predetermined wired communication standard such as a universal serial bus (USB) communication standard, wireless data communication with an external device according to a predetermined wireless communication standard such as a Bluetooth communication standard, or wireless or wired data communication with an external device via a predetermined network such as the Internet.

The calculating unit 10 can transmit and receive data to and from an external device via the communication unit 12.

### (2-3. Specific Example of Coefficient Derivation Method)

Here, in the past spectral sensitivity correction, an object is to appropriately correct the spectral sensitivity variation corresponding to any subject regardless of the type of the subject.

On the other hand, in the present embodiment, it is desirable not to be able to deal with any subject as in the past method, but to perform appropriate spectral sensitivity variation correction on a part of the subject by narrowing the target subject to the part.

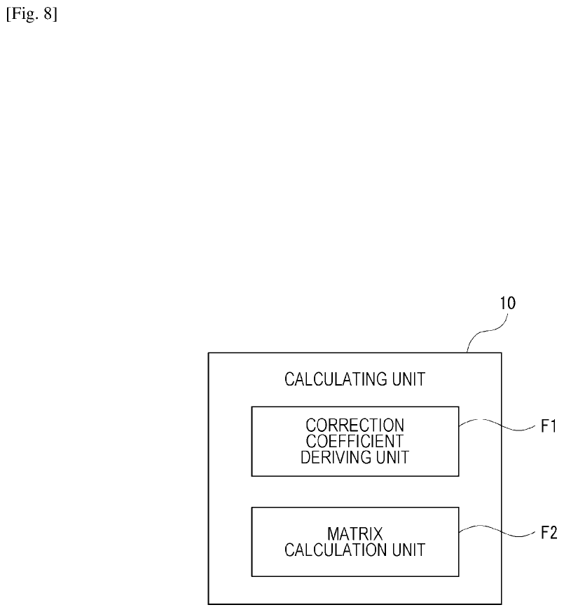

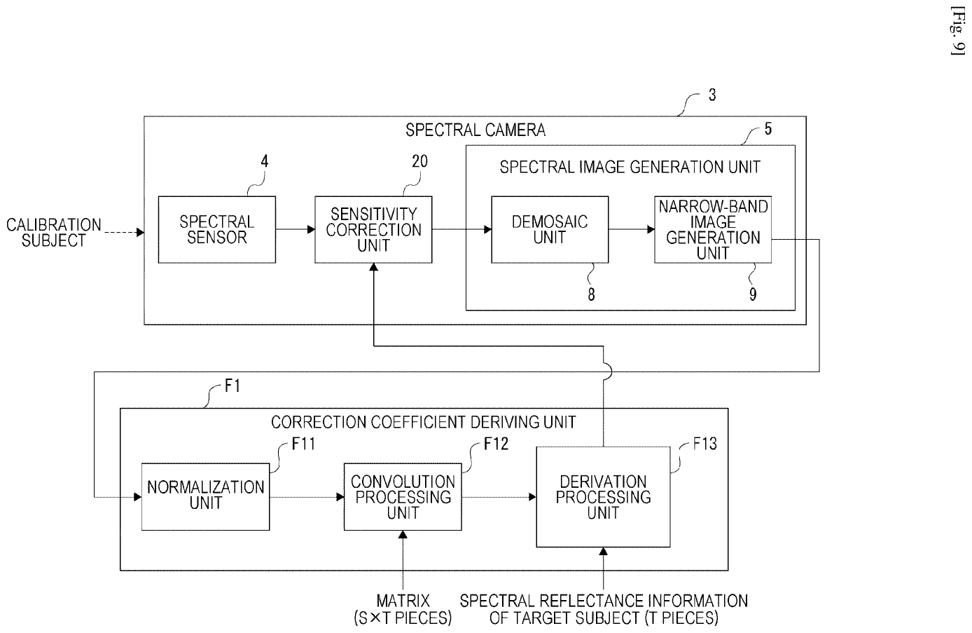

A specific example of a coefficient derivation method as an embodiment will be described with reference to FIGS. 8 and 9.

FIG. 8 is a functional block diagram illustrating each function for deriving the spectral sensitivity correction coefficient included in the calculating unit 10 in the information processing apparatus 1.

As illustrated in the drawing, the calculating unit 10 includes a correction coefficient deriving unit F1 and a matrix calculation unit F2 as functional units for deriving coefficients.

The correction coefficient deriving unit F1 derives the spectral sensitivity correction coefficient of the spectral sensor on the basis of the spectral characteristic information of the calibration subject and the spectral characteristic information of the target subject.

Specifically, the correction coefficient deriving unit F1 performs, on the spectral characteristic information of the calibration subject, convolution processing of bringing the spectral characteristic information of the calibration subject close to the spectral characteristic information of the target subject on the basis of the spectral characteristic information of the target subject, and derives a spectral sensitivity correction coefficient that minimizes an error between the spectral characteristic information of the calibration subject subjected to the convolution processing and the spectral characteristic information of the target subject.

Here, details of the coefficient derivation method as an embodiment using the spectral characteristic information of the calibration subject subjected to the convolution processing in this manner will be described again below.

The matrix calculation unit F2 calculates a matrix Mx which is a convolution coefficient used in the convolution processing described above.

The matrix Mx can be rephrased as a convolution coefficient that brings the spectral characteristic information of the calibration subject close to the spectral characteristic information of the target subject. Specifically, in the present example, the matrix Mx is a convolution coefficient for bringing spectral characteristic information obtained by sensing the calibration subject by the spectral sensor 4 close to the spectral characteristic information of the target subject.

The matrix Mx is calculated for each target subject for each calibration subject. That is, S×T matrices Mx are calculated.

Specifically, the S×T matrices Mx are calculated as convolution coefficients that minimize an error between the spectral reflectance information of the calibration subject and the spectral reflectance information of the target subject for each combination of the calibration subject and the target subject for which the spectral reflectance information is stored in the database 2.

As a method of deriving the convolution coefficient (matrix Mx) that minimizes the error between the spectral reflectance information of the calibration subject and the spectral reflectance information of the target subject, for example, it is conceivable to adopt a method of repeating processing, which performs convolution processing (approximation processing) using the matrix Mx as a candidate on the spectral reflectance information of the calibration subject and calculates the error between the spectral reflectance information of the calibration subject having undergone the convolution processing and the spectral reflectance information of the target subject, a predetermined number of times while changing the matrix Mx, and as a result, specifying the matrix Mx having the minimum error.

Alternatively, the derivation processing of the matrix Mx may be performed as processing using a least squares method, for example, processing using a regression analysis algorithm such as Ridge regression or Lasso regression, or processing using Tikhonov regularization.

Furthermore, it is also conceivable to perform the derivation processing of the matrix Mx by using a technology of artificial intelligence (AI). Specifically, an AI model having a function of bringing the input spectral characteristic information of the calibration subject close to the spectral characteristic information of the target subject is generated by machine learning. In this case, the machine learning of the AI model is performed by using input data for learning as the spectral characteristic information of the calibration subject and teacher data as the spectral characteristic information of the target subject.

Here, in the present specification, “deriving a coefficient that minimizes an error” does not necessarily mean obtaining a coefficient that absolutely minimizes an error, and it is only required to derive a coefficient at least to reduce the error. For example, a method of calculating an error for a plurality of candidate coefficients and deriving a coefficient having the smallest error as in the example described above, a method of deriving a coefficient by using a minimization algorithm such as the regression analysis algorithm described above, or the like may be used.

Note that, in the above description, an example has been described in which the calculation of the matrix Mx is performed by the information processing apparatus 1 (calculating unit 10), but it is also conceivable to perform the calculation of the matrix Mx by an apparatus other than the information processing apparatus 1.

FIG. 9 is a diagram for explaining a function of the correction coefficient deriving unit F1.

First, as a premise, the derivation of the spectral sensitivity correction coefficient in the present example requires sensing of the S calibration subjects, and thus the spectral camera 3 is used as illustrated in the drawing.

As illustrated, the correction coefficient deriving unit F1 includes a normalization unit F11, a convolution processing unit F12, and a derivation processing unit F13.

The normalization unit F11 normalizes the spectral information of the calibration subject obtained by the spectral camera 3. As described later, in the present example, in deriving the spectral sensitivity correction coefficient, the derivation processing unit F13 calculates an error between the spectral characteristic information of the calibration subject after the convolution processing using the matrix Mx and the spectral characteristic information of the target subject. However, at this time, the spectral characteristic information on the target subject side is spectral reflectance information while the spectral characteristic information of the calibration subject is spectral information (information indicating light intensity for each wavelength), and thus, in order to make them comparable, the normalization unit F11 performs normalization. Specifically, the normalization unit F11 normalizes (maximum value normalization) the spectral information of the calibration subject obtained by the spectral camera 4, that is, the value of the light intensity for each wavelength to a numerical value that can be compared with a reflectance.

Note that the normalization by the normalization unit F11 can also be performed on the spectral information after the convolution processing by the convolution processing unit F12.

Furthermore, it is also conceivable that in the derivation processing unit F13, the normalization is performed as processing of converting the spectral reflectance information of the target subject into a value that can be compared with the spectral information.

The convolution processing unit F12 brings the spectral characteristic of the calibration subject close to the spectral characteristic of the target subject by performing the convolution processing using the matrix Mx on the normalized spectral characteristic information (the normalized information corresponding to the spectral reflectance in the present example) of the calibration subject.

The convolution processing by the convolution processing unit F12 is performed by using S×T matrices Mx, and specifically, is processing of convoluting the spectral characteristic information of the calibration subjects with the corresponding T matrices Mx, respectively.

Here, the calibration subject to be processed among the S calibration subjects is denoted as a calibration subject [s] (s=0 to S−1), and the target subject to be processed among the T target subjects is denoted as a target subject [t] (t=0 to T−1). Furthermore, for the S×T matrices Mx, the combination of the calibration subject and the target subject to be calculated are denoted to be identifiable such that the matrix obtained by calculation for the combination of the calibration subject [s=0] and the target subject [t=0] is a matrix Mx [s0, t0], the matrix obtained by calculation for the combination of the calibration subject [s=1] and the target subject [t=1] is a matrix Mx [s1, t1], . . . , and the matrix obtained by calculation for the combination of the calibration subject [s=S−1] and the target subject [t=T−1] is a matrix Mx [sS−1, tT−1].

The convolution processing by the convolution processing unit F12 is performed as follows.

First, for the spectral characteristic information of the calibration subject [s=0], the convolution processing using T matrices Mx obtained by calculation for each combination of the calibration subject [s=0] and each target subject, such as the convolution processing using the matrix Mx [s0, t0], the convolution processing using the matrix Mx [s0, t1], the convolution processing using the matrix Mx [s0, t2], . . . , and the convolution processing using the matrix Mx [s0, tT−1], is performed. Furthermore, for the spectral characteristic information of the calibration subject [s=1], the convolution processing using T matrices Mx obtained by calculation for each combination of the calibration subject [s=1] and each target subject, such as the convolution processing using the matrix Mx [s1, to], the convolution processing using the matrix Mx [s1, t1], the convolution processing using the matrix Mx [s1, t2], . . . , and the convolution processing using the matrix Mx [s1, tT−1], is performed.

Furthermore, for the spectral characteristic information of the calibration subject [s=S−1], the convolution processing using T matrices Mx obtained by calculation for each combination of the calibration subject [s=S−1] and each target subject, such as the convolution processing using the matrix Mx [sS−1, t0], the convolution processing using the matrix Mx [sS−1, t1], the convolution processing using the matrix Mx [sS−1, t2], . . . , and the convolution processing using the matrix Mx [sS−1, tT−1], is performed. As described above, the convolution processing by the convolution processing unit F12 is processing of convolving the spectral characteristic information of the calibration subjects with the corresponding T matrices Mx, respectively.

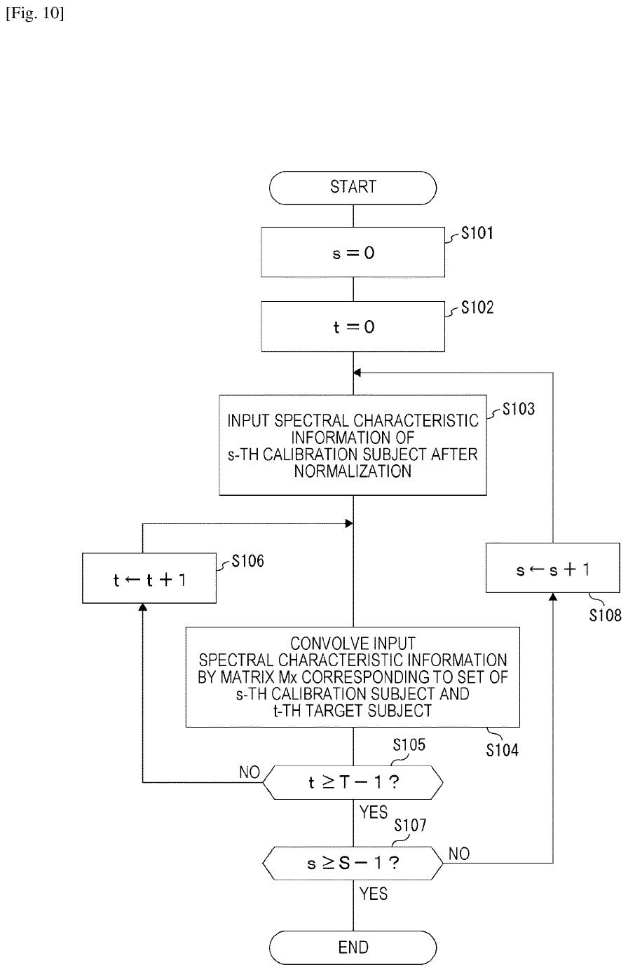

For confirmation, FIG. 10 illustrates a flowchart of the convolution processing by the convolution processing unit F12.

As illustrated, the convolution processing unit F12 resets a calibration subject identifier s to 0 in step S101, and resets a target subject identifier t to 0 in subsequent step S102.

In step S103 subsequent to step S102, the convolution processing unit F12 inputs the spectral characteristic information of the s-th calibration subject after the normalization, and further, in subsequent step S104, the input spectral characteristic information is convolved by the matrix Mx corresponding to the set of the s-th calibration subject and the t-th target subject.

In step S105 subsequent to step S104, the convolution processing unit F12 determines whether or not the target subject identifier t is T−1 or more. That is, it is determined whether or not the convolution has been performed on all of the T matrices Mx obtained by calculation for the s-th calibration subject.

In a case where it is determined in step S105 that the convolution has not been performed on all of the T matrices Mx obtained by calculation for the s-th calibration subject and the target subject identifier t is not equal to or greater than T−1, the convolution processing unit F12 proceeds to step S106, increments the target subject identifier t by 1, and returns to step S104.

On the other hand, in a case where it is determined in step S105 that the convolution has been performed on all of the T matrices Mx obtained by calculation for the s-th calibration subject and the target subject identifier t is equal to or greater than T−1, the convolution processing unit F12 proceeds to step S107 and determines whether or not the calibration subject identifier s is equal to or greater than S−1.

In a case where it is determined that the calibration subject identifier s is not equal to or greater than S−1, the convolution processing unit F12 proceeds to step S108, increments the calibration subject identifier s by 1, and returns to step S103.

On the other hand, in a case where it is determined that the calibration subject identifier s is not equal to or greater than S−1, the convolution processing unit F12 ends the series of processing illustrated in FIG. 10.

In FIG. 9, on the basis of the spectral characteristic information (the spectral reflectance information in the present example) of the T target subjects stored in the database 2, the derivation processing unit F13 calculates errors D of SXT pieces of spectral characteristic information after the convolution processing obtained by the convolution processing unit F12 from the respective corresponding spectral characteristic information of the target subjects, and derives the spectral sensitivity correction coefficient on the basis of the errors D.

For the error D, a total of S×T errors D are calculated by calculating the errors D of the S×T pieces of spectral characteristic information after the convolution processing from the spectral characteristic information of the target subject to be approximated by the convolution processing.

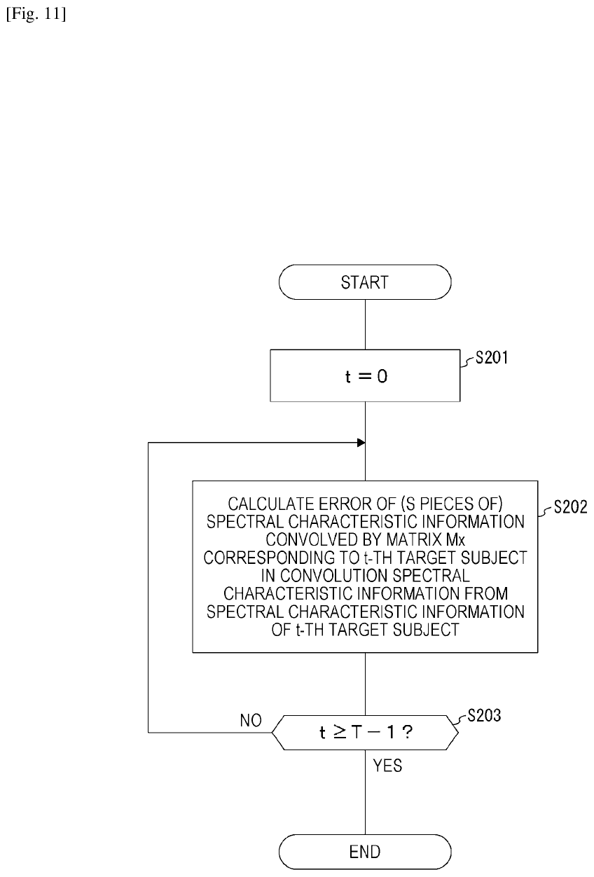

FIG. 11 is a flowchart of processing for calculating the SXT errors D.

The derivation processing unit F13 resets the target subject identifier t to 0 in step S201, and calculates the error D of (S pieces of) the spectral characteristic information convolved by the matrix Mx corresponding to the t-th target subject in (S×T pieces of) the convolution spectral characteristic information from the spectral characteristic information (the spectral reflectance information in the present example) of the t-th target subject in subsequent step S202.

In step S203 subsequent to step S202, the derivation processing unit F13 determines whether or not the target subject identifier t is equal to or greater than T−1. If the target subject identifier t is not equal to or greater than T−1, the derivation processing unit F13 executes the processing of step S202 again, and if the target subject identifier t is equal to or greater than T−1, the derivation processing unit F13 terminates the series of processing illustrated in FIG. 11.

In FIG. 9, the derivation processing unit F13 derives the spectral sensitivity correction coefficient on the basis of the S×T errors D obtained as described above.

In the present example, as an evaluation index in deriving the spectral sensitivity correction coefficient, a total error Ds comprehensively representing the S×T errors D is used instead of using the S×T errors D as they are. It is conceivable that, for example, an average value, a total value, a sum of squares, or the like of the errors D is calculated as the total error Ds.

The derivation processing unit F13 of the present example derives the spectral sensitivity correction coefficient that minimizes the total error Ds.

As a specific method, for example, a method can be exemplified in which processing of obtaining the total error Ds in a state where the spectral sensitivity correction coefficient as a candidate is set in the sensitivity correction unit 20 in the spectral camera 3 is performed a plurality of times while changing the spectral sensitivity correction coefficient as a candidate to be set, so that the total error Ds is acquired for each spectral sensitivity correction coefficient as a candidate, and the spectral sensitivity correction coefficient having the minimum total error Ds is derived.

Alternatively, it is also conceivable that the derivation processing of the spectral sensitivity correction coefficient by the derivation processing unit F13 is performed as processing using a least squares method, for example, processing using a regression analysis algorithm such as Ridge regression or Lasso regression, or processing using Tikhonov regularization.

Note that, also in this case, the definition of “minimization” is similar to the case of deriving the matrix Mx described above.

By adopting the coefficient derivation method as the embodiment as described above, it is possible to derive an appropriate spectral sensitivity correction coefficient corresponding to a case where the subject to be sensed by the spectral sensor is narrowed down to the target subject. Furthermore, by narrowing down the target subject, it is possible to reduce the number of calibration subjects used for coefficient derivation.

Accordingly, in a case where the subject to be sensed by the spectral sensor is narrowed down to the target subject, it is possible to reduce the time required for deriving the spectral sensitivity correction coefficient and reduce the processing load while ensuring the spectral sensitivity correction accuracy.

Furthermore, according to the coefficient derivation method as an embodiment, it is possible to eliminate the need to estimate the spectral sensitivity characteristic of the spectral sensor as in the related art in deriving the spectral sensitivity correction coefficient. Therefore, it is possible to prevent an estimation error of the spectral sensitivity characteristic from being propagated to the spectral sensitivity correction coefficient as an inverse matrix as in the related art, and in this respect, it is possible to enhance the derivation accuracy of the spectral sensitivity correction coefficient.

### (2-4. Image Processing Device as Embodiment)

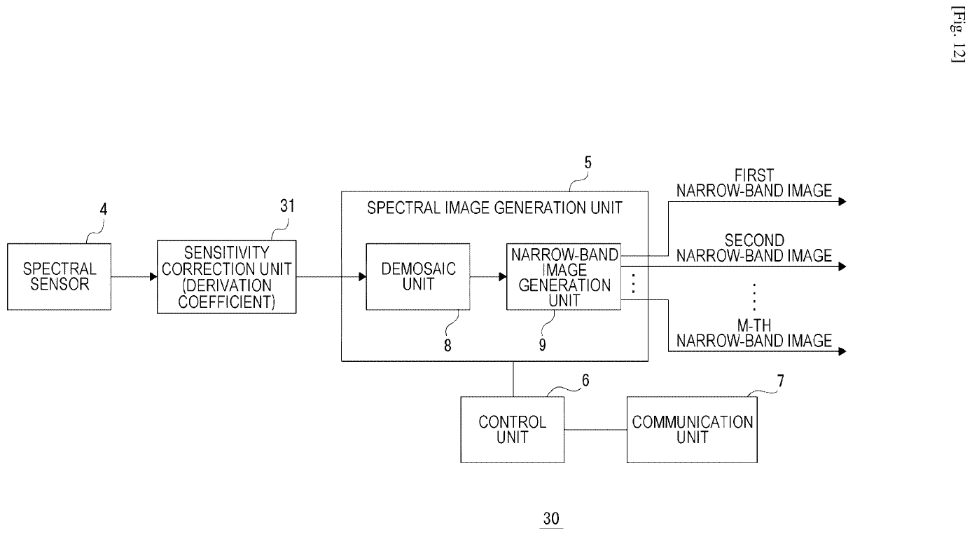

FIG. 12 is a block diagram illustrating a schematic configuration example of a spectral camera 30 which is one embodiment of an image processing device according to the present technology.

Note that, in the following description, the same reference numerals are given to portions similar to those already described, and description thereof will be omitted.

The spectral camera 30 of the embodiment is similar to the spectral camera 3 illustrated in FIG. 1 in including the spectral sensor 4, the spectral image generation unit 5, the control unit 6, and the communication unit 7, but is different from the spectral camera 3 in including a sensitivity correction unit 31 instead of the sensitivity correction unit 20.

The sensitivity correction unit 31 is different from the sensitivity correction unit 20 in that the spectral sensitivity correction coefficient derived by the information processing apparatus 1 by the coefficient derivation method as the above-described embodiment is set as the spectral sensitivity correction coefficient. That is, the sensitivity correction unit 31 in this case performs processing using the spectral sensitivity correction coefficient derived by the information processing apparatus 1 as the spectral sensitivity correction processing for the spectral image obtained on the basis of the output of the spectral sensor 4.

As understood from the above description, the spectral sensitivity correction coefficient derived by the information processing apparatus 1 by the coefficient derivation method as the embodiment is derived such that the processing amount required for deriving the spectral sensitivity correction coefficient can be reduced.

Accordingly, according to the spectral camera 30 as the embodiment that performs the spectral sensitivity correction by using such a spectral sensitivity correction coefficient, it is possible to reduce the time required for deriving the spectral sensitivity correction coefficient and reduce the processing load.

Furthermore, since it is possible to prevent the estimation error of the spectral sensitivity characteristic from being propagated to the spectral sensitivity correction coefficient as an inverse matrix as in the past method, it is possible to improve the accuracy of the spectral sensitivity correction.

### (2-5. Another Example of Embodiment)

In the above description, an example has been described in which the spectral sensitivity correction coefficient corresponding to a case where the spectral sensitivity correction processing is performed before the band-narrowing processing is derived. However, the spectral sensitivity correction coefficient can also be derived as a coefficient used in the band-narrowing processing. In other words, a coefficient having a function of increasing the input of Nch to Mch and a function of spectral sensitivity correction of the spectral sensor 4 is derived as the above-described band-narrowing coefficient C.

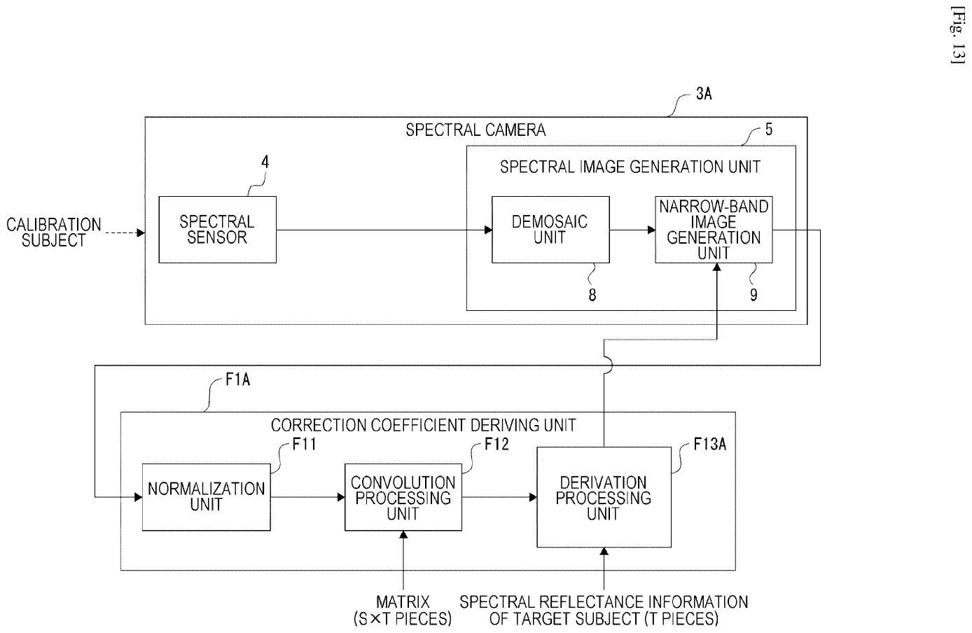

FIG. 13 is a diagram for explaining a function of a correction coefficient deriving unit F1A in another example of the embodiment that derives the spectral sensitivity correction coefficient as the coefficient used in the band-narrowing processing in this manner.

The correction coefficient deriving unit F1A is different from the correction coefficient deriving unit F1 in that a derivation processing unit F13A is included instead of the derivation processing unit F13.

Furthermore, in this case, as the spectral camera used for deriving the spectral sensitivity correction coefficient, a spectral camera 3A is used instead of the spectral camera 3. The spectral camera 3A is different from the spectral camera 3 in that the sensitivity correction unit 20 is omitted.

The derivation processing unit F13A performs similar processing to the derivation processing unit F13 except that a spectral sensitivity correction coefficient (a coefficient having a function of the band-narrowing processing: see [Equation 1] above) as a candidate is set in the narrow-band image generation unit 9 in deriving the spectral sensitivity correction coefficient.

Therefore, a coefficient having a function of correcting the spectral sensitivity variation of the spectral sensor 4 can be derived as the narrow-band-narrowing coefficient C set in the narrow-band image generation unit 9.

Also in this case, similarly to the case of the correction coefficient deriving unit F1, the derivation of the coefficient is performed by using the spectral characteristic information of the target subject, so that the time required for deriving the coefficient can be reduced, and the processing load can be reduced.

Furthermore, since it is possible to prevent the estimation error of the spectral sensitivity characteristic from being propagated to the spectral sensitivity correction coefficient as an inverse matrix as in the past method, it is possible to improve the accuracy of the spectral sensitivity correction.

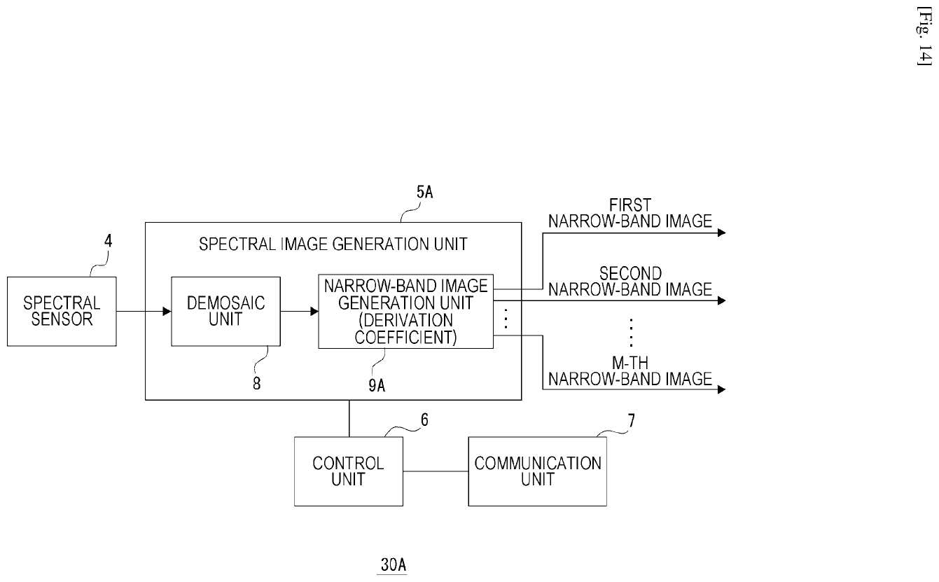

FIG. 14 is a block diagram illustrating a schematic configuration example of a spectral camera 30A as another example of the embodiment.

The spectral camera 30A is different from the spectral camera 30 illustrated in FIG. 12 in that the sensitivity correction unit 31 is omitted and that a spectral image generation unit 5A is provided instead of the spectral image generation unit 5.

The spectral image generation unit 5A is different from the spectral image generation unit 5 in that a narrow-band image generation unit 9A is included instead of the narrow-band image generation unit 9.

The narrow-band image generation unit 9A is different from the narrow-band image generation unit 9 in that a coefficient derived by the correction coefficient deriving unit F1A described above is set as the band-narrowing coefficient C.

According to the spectral camera 30A as such another example, it is not necessary to separately provide a configuration for performing the spectral sensitivity correction at a preceding stage of the band-narrowing processing, and it is possible to reduce the number of components of the spectral camera 30A and a manufacturing cost.

Note that it is also conceivable that the spectral sensitivity correction is performed on the spectral information of Mch after the band-narrowing processing. In this case, the spectral sensitivity correction coefficient is derived as a coefficient for the spectral information of Mch after the band-narrowing processing.

### 3. Modifications

Note that the embodiment is not limited to the specific example described above, and may be configured as various modifications.

For example, in the above description, an example has been described in which the information processing apparatus 1 acquires spectral reflectance information of the calibration subject and spectral reflectance information of the target subject used for coefficient derivation from the external database 2, but it is also conceivable to adopt a configuration in which a storage device for storing the spectral reflectance information is provided in the information processing apparatus 1.

Furthermore, in the above description, the device form of the spectral camera including the spectral sensor 4 has been exemplified as the device form of the image processing device according to the present technology, but the image processing device according to the present technology may also adopt a device form not including the spectral sensor 4 or the demosaic unit 8. For example, it is conceivable that the spectral sensor 4 is provided in an external device, and an output from the spectral sensor 4 is input to perform the demosaic processing and the band-narrowing processing. Alternatively, a device form is also conceivable in which the spectral sensor 4 and the demosaic unit 8 are provided in an external device, and the band-narrowing processing is performed on the spectral image after the demosaic processing output from the external device.

### 4. Program

Here, as the embodiment, a program can be considered, for example, for causing a CPU, a digital signal processor (DSP), or the like, or a device including the CPU, the DSP, or the like, to execute the function as the correction coefficient deriving unit F1 (or F1A) described with reference to FIGS. 9 to 11 and the like.

That is, the program of the embodiment is a program that is readable by a computer device and causes the computer device to realize a function of deriving a spectral sensitivity correction coefficient of a spectral sensor on the basis of calibration subject spectral characteristic information that is spectral characteristic information obtained on the basis of a sensing result of the spectral sensor for a calibration subject having a known spectral characteristic and spectral characteristic information of a target subject that is a subject different from the calibration subject and has a known spectral characteristic.

With such a program, the function as the correction coefficient deriving unit F1 (F1A) described above can be realized in a device as the information processing apparatus 1 or the like.

Such a program can be recorded in advance in a hard disc drive (HDD) as a recording medium built in a device such as a computer device, a ROM in a microcomputer having a CPU, or the like.

Alternatively, the program can be temporarily or permanently stored (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable recording medium can be provided as so-called package software.

Furthermore, such a program can be installed from the removable recording medium into a personal computer or the like, or can be downloaded from a download site via a network such as a local area network (LAN) or the Internet.

Furthermore, such a program is suitable for a wide range of provision of the coefficient derivation method of the embodiment. For example, by downloading the program to a mobile terminal device such as a personal computer, a portable information processing apparatus, a mobile phone, a game device, a video device, a personal digital assistant (PDA), or the like, the personal computer or the like can be caused to function as a device that achieves the coefficient derivation method of the present disclosure.

### 4. Notes

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

The methods and systems described herein may be implemented using computer programming or engineering techniques including computer software, firmware, hardware or any combination or subset thereof, wherein the technical effects may include at least lossless encoding and decoding using inverse orthogonal transforms in an image processing system.

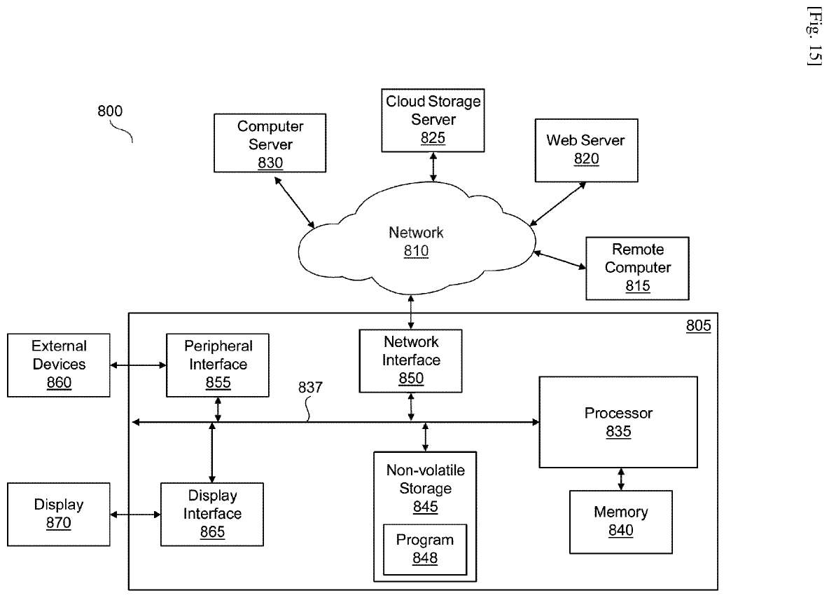

FIG. 15 illustrates a block diagram of a computer that may implement the various embodiments described herein.

The present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A nonexhaustive list of more specific examples of the computer readable storage medium includes each of the following (and appropriate combinations): flexible disk, hard disk, solid-state drive (SSD), random access memory (RAM), read-only memory (ROM), erasable programmable readonly memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or compute server, or any combination of these computing devices. The remote computer or compute server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 15 is a functional block diagram illustrating a networked system 800 of one or more networked computers and servers. In an embodiment, the hardware and software environment illustrated in FIG. 15 may provide an exemplary platform for implementation of the software and/or methods according to the present disclosure.

Referring to FIG. 15, a networked system 800 may include, but is not limited to, computer 805, network 810, remote computer 815, web server 820, cloud storage server 825 and compute server 830. In some embodiments, multiple instances of one or more of the functional blocks illustrated in FIG. 15 may be employed.

Additional detail of computer 805 is shown in FIG. 15. The functional blocks illustrated within computer 805 are provided only to establish exemplary functionality and are not intended to be exhaustive. And while details are not provided for remote computer 815, web server 820, cloud storage server 825 and compute server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 837 may be a proprietary or industry standard high-speed parallel or serial peripheral interconnect bus, such as ISA, PCI, PCI Express (PCI-e), AGP, and the like.

Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and compute server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and computer server 830. Combination of connections and protocols that support communications between two or more computers and related devices.

Obviously, numerous modifications and variations of the present invention are possible in light of the above teachings. It is therefore to be understood that within the scope of the appended claims, the invention may be practiced otherwise than as specifically described herein.

### 6. Summary of Embodiment

As described above, the information processing apparatus (1) as the embodiment includes a coefficient deriving unit (correction coefficient deriving unit F1, F1A) that derives a spectral sensitivity correction coefficient of a spectral sensor on the basis of calibration subject spectral characteristic information that is spectral characteristic information obtained on the basis of a sensing result of the spectral sensor for a calibration subject having a known spectral characteristic and spectral characteristic information of a target subject that is a subject different from the calibration subject and has a known spectral characteristic.

When the spectral characteristic information of the target subject is used to derive the spectral sensitivity correction coefficient, it is possible to derive the spectral sensitivity correction coefficient corresponding to a case where the subject to be sensed by the spectral sensor is narrowed down to the target subject, instead of deriving the spectral sensitivity correction coefficient corresponding to any subject, which enables reduction in the number of samples required for deriving the spectral sensitivity correction coefficient and reduction in the processing amount required for deriving the spectral sensitivity correction coefficient.

Accordingly, the time required for deriving the spectral sensitivity correction coefficient of the spectral sensor can be reduced, and the processing load can be reduced.

Furthermore, in the information processing apparatus as an embodiment, the coefficient deriving unit performs, on the spectral characteristic information of the calibration subject, convolution processing of bringing the spectral characteristic information of the calibration subject close to the spectral characteristic information of the target subject on the basis of the spectral characteristic information of the target subject, and derives the spectral sensitivity correction coefficient that minimizes an error between the spectral characteristic information of the calibration subject subjected to the convolution processing and the spectral characteristic information of the target subject.

Therefore, it is possible to derive an appropriate spectral sensitivity correction coefficient corresponding to a case where the subject to be sensed by the spectral sensor is narrowed down to the target subject.

Accordingly, in a case where the subject to be sensed by the spectral sensor is narrowed down to the target subject, it is possible to reduce the time required for deriving the spectral sensitivity correction coefficient and reduce the processing load while ensuring the spectral sensitivity correction accuracy.

Furthermore, according to the above configuration, it is possible to eliminate the need to estimate the spectral sensitivity characteristic of the spectral sensor as in the related art in deriving the spectral sensitivity correction coefficient. Therefore, it is possible to prevent an estimation error of the spectral sensitivity characteristic from being propagated to the spectral sensitivity correction coefficient as an inverse matrix as in the related art, and in this respect, it is possible to enhance the derivation accuracy of the spectral sensitivity correction coefficient.

Furthermore, in the information processing apparatus as the embodiment, a convolution coefficient (matrix Mx) used in the convolution processing is derived as a coefficient that minimizes the error between the spectral characteristic information of the calibration subject and the spectral characteristic information of the target subject.

By using the convolution coefficient derived to minimize the error between the spectral characteristic information of the calibration subject and the spectral characteristic information of the target subject in this manner, the spectral characteristic information of the calibration subject can be brought close to the spectral characteristic information of the target subject.

Moreover, in the information processing apparatus as the embodiment, the coefficient deriving unit includes derives the spectral sensitivity correction coefficient on the basis of the spectral characteristic information of a plurality of the calibration subjects and the spectral characteristic information of a plurality of the target subjects.

That is, the number of samples used for deriving the spectral sensitivity correction coefficient is plural.

In this way, by setting the number of samples used for deriving the spectral sensitivity correction coefficient to be plural, the application range of the derived spectral sensitivity correction coefficient can be expanded.

Furthermore, in the information processing apparatus as the embodiment, the coefficient deriving unit (correction coefficient deriving unit F1) derives the spectral sensitivity correction coefficient for performing spectral sensitivity correction of the spectral sensor at a preceding stage of band-narrowing processing of generating a spectral image with a larger number of wavelengths than the number of output wavelengths of the spectral sensor on the basis of an output of the spectral sensor (see FIG. 9).

Since the spectral sensitivity correction in this case is performed on spectral information of a number of wavelengths smaller than the number of wavelengths after the band-narrowing processing, the number of coefficients to be obtained as the spectral sensitivity correction coefficients can also be reduced, the processing time required for deriving the spectral sensitivity correction coefficients can be reduced, and the processing load can be reduced.

Furthermore, in the information processing apparatus as the embodiment, the coefficient deriving unit (correction coefficient deriving unit F1A) derives the spectral sensitivity correction coefficient as a coefficient to be used in band-narrowing processing of generating a spectral image with a larger number of wavelengths than the number of output wavelengths of the spectral sensor on the basis of an output of the spectral sensor (see FIG. 13).

Therefore, in the spectral camera to which the derived spectral sensitivity correction coefficient is applied, it is not necessary to separately provide the spectral sensitivity correction unit at a preceding stage of the band-narrowing processing.

Accordingly, the number of components of the spectral camera can be reduced, and the manufacturing cost can be reduced.

An information processing method as the embodiment includes deriving, by an information processing apparatus, a spectral sensitivity correction coefficient of a spectral sensor on the basis of calibration subject spectral characteristic information that is spectral characteristic information obtained on the basis of a sensing result of the spectral sensor for a calibration subject having a known spectral characteristic and spectral characteristic information of a target subject that is a subject different from the calibration subject and has a known spectral characteristic.

With such an information processing method, functions and effects similar to functions and effects of the information processing apparatus as the embodiment described above can be obtained.

Moreover, a program of the embodiment is a program that is readable by a computer device and causes the computer device to realize a function of deriving a spectral sensitivity correction coefficient of a spectral sensor on the basis of calibration subject spectral characteristic information that is spectral characteristic information obtained on the basis of a sensing result of the spectral sensor for a calibration subject having a known spectral characteristic and spectral characteristic information of a target subject that is a subject different from the calibration subject and has a known spectral characteristic.

With such a program, the information processing apparatus as the embodiment described above can be achieved.

An image processing device (spectral camera 30, 30A) as the embodiment includes a spectral sensitivity correction unit (sensitivity correction unit 31, narrow-band image generation unit 9A) that performs spectral sensitivity correction processing on a spectral image obtained on the basis of an output of a spectral sensor by using a spectral sensitivity correction coefficient derived by an information processing apparatus (1) including a coefficient deriving unit (correction coefficient deriving unit F1, F1A) that derives the spectral sensitivity correction coefficient of the spectral sensor on the basis of calibration subject spectral characteristic information that is spectral characteristic information obtained on the basis of a sensing result of the spectral sensor for a calibration subject having a known spectral characteristic and spectral characteristic information of a target subject that is a subject different from the calibration subject and has a known spectral characteristic.

The spectral sensitivity correction coefficient derived by the information processing apparatus as described above is derived such that the processing amount required for deriving the spectral sensitivity correction coefficient can be reduced.

Accordingly, according to the image processing device as the embodiment that performs the spectral sensitivity correction by using such a spectral sensitivity correction coefficient, it is possible to reduce the time required for deriving the spectral sensitivity correction coefficient and reduce the processing load.

Furthermore, in the image processing device (spectral camera 30) as the embodiment, the spectral sensitivity correction unit (sensitivity correction unit 31) performs the spectral sensitivity correction processing at a preceding stage of band-narrowing processing of generating a spectral image with a larger number of wavelengths than the number of output wavelengths of the spectral sensor as the spectral image.

Since the spectral sensitivity correction in this case is performed on spectral information of a number of wavelengths smaller than the number of wavelengths after the band-narrowing processing, the number of coefficients to be obtained as the spectral sensitivity correction coefficients can also be reduced, the processing time required for deriving the spectral sensitivity correction coefficients can be reduced, and the processing load can be reduced.

Moreover, in the image processing device (spectral camera 30A) as the embodiment, the spectral sensitivity correction unit (narrow-band image generation unit 9A) performs the spectral sensitivity correction processing in band-narrowing processing of generating a spectral image with a larger number of wavelengths than the number of output wavelengths of the spectral sensor as the spectral image.

Therefore, it is not necessary to separately provide a configuration for performing the spectral sensitivity correction at a preceding stage of the band-narrowing processing.

Accordingly, the number of components of the spectral camera can be reduced, and the manufacturing cost can be reduced.

An image processing method as the embodiment is an image processing method of performing, by an Image processing device, spectral sensitivity correction processing on a spectral image obtained on the basis of an output of a spectral sensor by using a spectral sensitivity correction coefficient derived by an information processing apparatus including a coefficient deriving unit that derives the spectral sensitivity correction coefficient of the spectral sensor on the basis of calibration subject spectral characteristic information that is spectral characteristic information obtained on the basis of a sensing result of the spectral sensor for a calibration subject having a known spectral characteristic and spectral characteristic information of a target subject that is a subject different from the calibration subject and has a known spectral characteristic.

With such an image processing method, functions and effects similar to functions and effects of the image processing device as the embodiment described above can be obtained.

Note that the effects described in the present specification are merely examples and are not limited, and other effects may be provided.

It should be understood by those skilled in the art that various modifications, combinations, sub-combinations and alterations may occur depending on design requirements and other factors insofar as they are within the scope of the appended claims or the equivalents thereof.

### 7. Present Technology

The present technology can also adopt the following configurations.

(1)

An information processing apparatus including:
a coefficient deriving unit that derives a spectral sensitivity correction coefficient of a spectral sensor on the basis of calibration subject spectral characteristic information that is spectral characteristic information obtained on the basis of a sensing result of the spectral sensor for a calibration subject having a known spectral characteristic and spectral characteristic information of a target subject that is a subject different from the calibration subject and has a known spectral characteristic.
   (2)

The information processing apparatus according to (1), in which
the coefficient deriving unit
performs, on the spectral characteristic information of the calibration subject, convolution processing of bringing the spectral characteristic information of the calibration subject closer to the spectral characteristic information of the target subject on the basis of the spectral characteristic information of the target subject, and
derives the spectral sensitivity correction coefficient that minimizes an error between the spectral characteristic information of the calibration subject subjected to the convolution processing and the spectral characteristic information of the target subject.
   (3)

The information processing apparatus according to (2), in which
a convolution coefficient used in the convolution processing is derived as a coefficient that minimizes the error between the spectral characteristic information of the calibration subject and the spectral characteristic information of the target subject.
   (4)

The information processing apparatus according to any one of (1) to (3), in which
the coefficient deriving unit derives the spectral sensitivity correction coefficient on the basis of the spectral characteristic information of a plurality of the calibration subjects and the spectral characteristic information of a plurality of the target subjects.
   (5)

The information processing apparatus according to any one of (1) to (4), in which
the coefficient deriving unit derives the spectral sensitivity correction coefficient for performing spectral sensitivity correction of the spectral sensor at a preceding stage of band-narrowing processing of generating a spectral image with a larger number of wavelengths than the number of output wavelengths of the spectral sensor on the basis of an output of the spectral sensor.
   (6)

The information processing apparatus according to any one of (1) to (4), in which
the coefficient deriving unit derives the spectral sensitivity correction coefficient as a coefficient to be used in band-narrowing processing of generating a spectral image with a larger number of wavelengths than the number of output wavelengths of the spectral sensor on the basis of an output of the spectral sensor.
   (7)

An information processing method including:
deriving, by an information processing apparatus, a spectral sensitivity correction coefficient of a spectral sensor on the basis of calibration subject spectral characteristic information that is spectral characteristic information obtained on the basis of a sensing result of the spectral sensor for a calibration subject having a known spectral characteristic and spectral characteristic information of a target subject that is a subject different from the calibration subject and has a known spectral characteristic.
   (8)

A program readable by a computer device, the program causing the computer device to realize a function including:
deriving a spectral sensitivity correction coefficient of a spectral sensor on the basis of calibration subject spectral characteristic information that is spectral characteristic information obtained on the basis of a sensing result of the spectral sensor for a calibration subject having a known spectral characteristic and spectral characteristic information of a target subject that is a subject different from the calibration subject and has a known spectral characteristic.
   (9)

An image processing device including:
a spectral sensitivity correction unit that performs spectral sensitivity correction processing on a spectral image obtained on the basis of an output of a spectral sensor by using a spectral sensitivity correction coefficient derived by an information processing apparatus including a coefficient deriving unit that derives the spectral sensitivity correction coefficient of the spectral sensor on the basis of calibration subject spectral characteristic information that is spectral characteristic information obtained on the basis of a sensing result of the spectral sensor for a calibration subject having a known spectral characteristic and spectral characteristic information of a target subject that is a subject different from the calibration subject and has a known spectral characteristic.
   (10)

The image processing device according to (9), in which
the spectral sensitivity correction unit performs the spectral sensitivity correction processing at a preceding stage of band-narrowing processing of generating a spectral image with a larger number of wavelengths than the number of output wavelengths of the spectral sensor as the spectral image.
   (11)

The image processing device according to (9), in which
the spectral sensitivity correction unit performs the spectral sensitivity correction processing in band-narrowing processing of generating a spectral image with a larger number of wavelengths than the number of output wavelengths of the spectral sensor as the spectral image.
   (12)

An image processing method including:
performing, by an Image processing device, spectral sensitivity correction processing on a spectral image obtained on the basis of an output of a spectral sensor by using a spectral sensitivity correction coefficient derived by an information processing apparatus including a coefficient deriving unit that derives the spectral sensitivity correction coefficient of the spectral sensor on the basis of calibration subject spectral characteristic information that is spectral characteristic information obtained on the basis of a sensing result of the spectral sensor for a calibration subject having a known spectral characteristic and spectral characteristic information of a target subject that is a subject different from the calibration subject and has a known spectral characteristic.

### REFERENCE SIGNS LIST

1 Information processing apparatus
2 Database
3, 3A Spectral camera
4 Spectral sensor
4a Pixel array unit
5, 5A Spectral image generation unit
6 Control unit
7 Communication unit
8 Demosaic unit
9, 9A Narrow-band image generation unit
20, 31 Sensitivity correction unit
Px Pixel
Pu Spectral pixel unit
I1 Calibration subject spectral reflectance information
I2 Target subject spectral reflectance information
10 Calculating unit
11 Operation unit
12 Communication unit
F1, F1A Correction coefficient deriving unit
F2 Matrix calculation unit
F11 Normalization unit
F12 Convolution processing unit
F13, F13A Derivation processing unit
Mx Matrix
30, 30A Spectral camera

1. An information processing apparatus comprising:
a coefficient deriving unit that derives a spectral sensitivity correction coefficient of a spectral sensor on a basis of calibration subject spectral characteristic information that is spectral characteristic information obtained on a basis of a sensing result of the spectral sensor for a calibration subject having a known spectral characteristic and spectral characteristic information of a target subject that is a subject different from the calibration subject and has a known spectral characteristic.

2. The information processing apparatus according to claim 1, wherein the coefficient deriving unit performs, on the spectral characteristic information of the calibration subject, convolution processing of bringing the spectral characteristic information of the calibration subject closer to the spectral characteristic information of the target subject on a basis of the spectral characteristic information of the target subject, and
derives the spectral sensitivity correction coefficient that minimizes an error between the spectral characteristic information of the calibration subject subjected to the convolution processing and the spectral characteristic information of the target subject.

3. The information processing apparatus according to claim 2, wherein a convolution coefficient used in the convolution processing is derived as a coefficient that minimizes the error between the spectral characteristic information of the calibration subject and the spectral characteristic information of the target subject.

4. The information processing apparatus according to claim 1, wherein the coefficient deriving unit derives the spectral sensitivity correction coefficient on a basis of the spectral characteristic information of a plurality of the calibration subjects and the spectral characteristic information of a plurality of the target subjects.

5. The information processing apparatus according to claim 1, wherein the coefficient deriving unit derives the spectral sensitivity correction coefficient for performing spectral sensitivity correction of the spectral sensor at a preceding stage of band-narrowing processing of generating a spectral image with a larger number of wavelengths than the number of output wavelengths of the spectral sensor on a basis of an output of the spectral sensor.

6. The information processing apparatus according to claim 1, wherein the coefficient deriving unit derives the spectral sensitivity correction coefficient as a coefficient to be used in band-narrowing processing of generating a spectral image with a larger number of wavelengths than the number of output wavelengths of the spectral sensor on a basis of an output of the spectral sensor.

7. An information processing method comprising:
deriving, by an information processing apparatus, a spectral sensitivity correction coefficient of a spectral sensor on a basis of calibration subject spectral characteristic information that is spectral characteristic information obtained on a basis of a sensing result of the spectral sensor for a calibration subject having a known spectral characteristic and spectral characteristic information of a target subject that is a subject different from the calibration subject and has a known spectral characteristic.

8. A program readable by a computer device, the program causing the computer device to realize a function comprising:
deriving a spectral sensitivity correction coefficient of a spectral sensor on a basis of calibration subject spectral characteristic information that is spectral characteristic information obtained on a basis of a sensing result of the spectral sensor for a calibration subject having a known spectral characteristic and spectral characteristic information of a target subject that is a subject different from the calibration subject and has a known spectral characteristic.

9. An image processing device comprising:
a spectral sensitivity correction unit that performs spectral sensitivity correction processing on a spectral image obtained on a basis of an output of a spectral sensor by using a spectral sensitivity correction coefficient derived by an information processing apparatus including a coefficient deriving unit that derives the spectral sensitivity correction coefficient of the spectral sensor on a basis of calibration subject spectral characteristic information that is spectral characteristic information obtained on a basis of a sensing result of the spectral sensor for a calibration subject having a known spectral characteristic and spectral characteristic information of a target subject that is a subject different from the calibration subject and has a known spectral characteristic.

10. The image processing device according to claim 9, wherein the spectral sensitivity correction unit performs the spectral sensitivity correction processing at a preceding stage of band-narrowing processing of generating a spectral image with a larger number of wavelengths than the number of output wavelengths of the spectral sensor as the spectral image.

11. The image processing device according to claim 9, wherein the spectral sensitivity correction unit performs the spectral sensitivity correction processing in band-narrowing processing of generating a spectral image with a larger number of wavelengths than the number of output wavelengths of the spectral sensor as the spectral image.

12. An image processing method comprising:
performing, by an Image processing device, spectral sensitivity correction processing on a spectral image obtained on a basis of an output of a spectral sensor by using a spectral sensitivity correction coefficient derived by an information processing apparatus including a coefficient deriving unit that derives the spectral sensitivity correction coefficient of the spectral sensor on a basis of calibration subject spectral characteristic information that is spectral characteristic information obtained on a basis of a sensing result of the spectral sensor for a calibration subject having a known spectral characteristic and spectral characteristic information of a target subject that is a subject different from the calibration subject and has a known spectral characteristic.
